(19) United States
(12) Patent Application Publication
(10) Pub. No.: US 2025/0278369 A1
(43) Pub. Date: Sep. 4, 2025

(54) METHODS OF DETERMINING DATA HOTNESS, MEMORY CONTROLLERS, AND MEMORY SYSTEMS

(71) Applicant: Yangtze Memory Technologies Co., Ltd., Wuhan (CN)

(72) Inventor: Jingsheng Liu, Wuhan (CN)

(21) Appl. No.: 18/784,320

(22) Filed: Jul. 25, 2024

(30) Foreign Application Priority Data
Feb. 29, 2024 (CN) 202410229602.8

(51) Int. Cl. G06F 12/1009; G06F 12/02

(52) U.S. Cl. CPC G06F 12/1009; G06F 12/0246; G06F 12/0253

(57) ABSTRACT

The present disclosure relates to the technical field of data storage, and discloses a method of determining data hotness, a memory controller, and a memory system. The method includes: acquiring a page table entry region count corresponding to a virtual block and a valid data count of the virtual block, wherein the virtual block includes at least one memory block in a memory device; determining a data distribution state of data stored in the virtual block based on the page table entry region count and the valid data count; and determining data hotness of the data stored in the virtual block based on the data distribution state.

### CROSS-REFERENCE TO RELATED APPLICATION

The present disclosure claims the benefit of priority to China Application No. 202410229602.8, filed on Feb. 29, 2024, the content of which is incorporated herein by reference in its entirety.

### TECHNICAL FIELD

The present disclosure relates to the technical field of data storage, and in examples to methods of determining data hotness, memory controllers, and memory systems.

### BACKGROUND

As data storage technologies develop by leaps and bounds, increasingly more data memory systems are present in electronic apparatuses used by people, e.g., Solid State Drives (SSDs), etc. Because of characteristics such as fast read and write speeds, vibration resistance, low power consumption, noiselessness, low heat, and light weight, etc., SSDs have been widely applied in various fields.

### BRIEF DESCRIPTION OF THE DRAWINGS

The drawings to be used in description of example implementations or the prior art are briefly introduced as follows to illustrate the technical solutions in the example implementations of the present disclosure or the prior art more clearly. Apparently, the drawings described below are some implementations of the present disclosure. One of oridinary skills in the art may also obtain other drawings according to such drawings without the exercise of inventive effort.

FIG. 1 is a schematic structural diagram of a system of a memory controller according to examples of the present disclosure;

FIG. 2 is a schematic structural diagram of a memory device comprising a memory cell array according to examples of the present disclosure;

FIG. 3 is a schematic structural diagram of a memory device comprising a peripheral circuit according to examples of the present disclosure;

FIG. 4 is another schematic structural diagram of a system of a memory controller according to examples of the present disclosure;

FIG. 5 is a schematic diagram of a memory card according to examples of the present disclosure;

FIG. 6 is a schematic diagram of a solid state drive according to examples of the present disclosure;

FIG. 7 is a schematic diagram of mapping a logical block address to a physical address based on an L2P table according to examples of the present disclosure;

FIG. 8 is a schematic diagram of a structure of an L2P table according to examples of the present disclosure;

FIG. 9 is a schematic flow diagram of a method of determining data hotness according to examples of the present disclosure;

FIG. 10 is a schematic diagram of a virtual block according to examples of the present disclosure;

FIG. 11 is a schematic diagram of a data distribution state according to examples of the present disclosure;

FIG. 12 is a schematic flow diagram of another method of determining data hotness according to examples of the present disclosure;

FIG. 13 is a schematic diagram of a page table entry bitmap according to examples of the present disclosure;

FIG. 14 is a schematic flow diagram of yet another method of determining data hotness according to examples of the present disclosure;

FIG. 15 is a schematic flow diagram of yet another method of determining data hotness according to examples of the present disclosure; and

FIG. 16 is a schematic flow diagram of yet still another method of determining data hotness according to examples of the present disclosure.

### DETAILED DESCRIPTION

In order to make the purposes, technical solutions and advantages of examples of the present disclosure clearer, the technical solutions in the examples of the present disclosure will be described below clearly and completely in conjunction with the drawings in the examples of the present disclosure. Apparently, the examples described are only part, but not all, of the examples of the present disclosure. Based on the examples in the present disclosure, all other examples obtained by a person skilled in the art without the exercise of inventive effort fall within the scope of protection of the present disclosure.

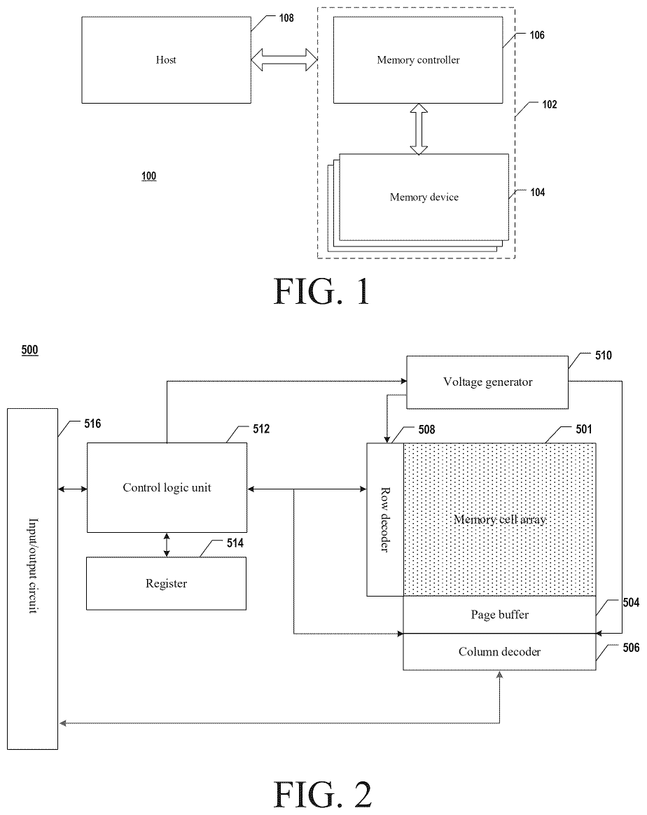

FIG. 1 illustrates a block diagram of an example system 100 having a memory controller according to some aspects of the present disclosure. The system 100 may be a mobile phone, a desktop computer, a laptop computer, a tablet computer, a vehicle computer, a gaming console, a printer, a positioning apparatus, a wearable electronic apparatus, a smart sensor, a virtual reality (VR) apparatus, an augmented reality (AR) apparatus, or any other suitable electronic apparatuses having memories therein.

As shown in FIG. 1, the system 100 may comprise a host 108 and a memory system 102, wherein the memory system 102 has one or more memory devices 104 and a memory controller 106. The host 108 may be a processor (e.g., a central processing unit (CPU)) or a system on chip (SOC) (e.g., an application processor (AP)) of an electronic apparatus. The host 108 may be configured to send or receive data to or from the memory device 104.

The memory device 104 may be any memory device, for example, the memory device 104 may include a phase change memory (PCM), a magnetoresistive random access memory (MRAM), a ferroelectric random access memory (FRAM), a NAND flash, a NOR flash, a vertical NAND flash (e.g., a three-dimensional NAND flash), a spin transfer torque random access memory (STT-RAM), etc.

In some examples of the present disclosure, the memory device 104 may include a flash, such as a NAND flash. Referring to a schematic structural diagram of a memory device comprising a memory cell array as shown in FIG. 2, the memory device 500 (which may correspond to the memory device 104 in FIG. 1) may comprise a memory cell array 501, a page buffer 504, a column decoder 506, a row decoder 508, a voltage generator 510, a control logic unit 512, a register 514, and an input/output circuit 516. It is to be understood that, in some examples, additional peripheral circuits not shown in FIG. 2 may be included as well.

The page buffer 504 may be configured to read and program (write) data from and to the memory cell array 501 according to a control signal from the control logic unit 512. In one example, the page buffer 504 may store data (write data) to be programmed into a selected page of the memory cell array 301. In another example, the page buffer 504 may output read data in a program verification operation to ensure that the data has been properly programmed into a corresponding memory cell coupled to a selected word line of the memory cell array 501. The column decoder 506 may operate in response to the control signal provided by the control logic unit 512, so as to select one or more memory cell strings in the memory cell array 501. The row decoder 508 may operate in response to the control signal provided by the control logic unit 512, and select/unselect a selected row of the memory cell array 501. The row decoder 508 may further be configured to supply a voltage generated from the voltage generator 510 to a selected word line and unselected word line of the memory cell array 501. As described below in detail, the row decoder 508 is configured to execute an erase operation on memory cells coupled to one or more selected word lines in the memory cell array 501. The voltage generator 510 may use an external supply voltage or an internal supply voltage to generate various voltages required by the memory device, such as a program voltage, a read voltage, a pass voltage, a verify voltage, a bit line voltage, etc., and combinations thereof.

The control logic unit 512 may be coupled to the voltage generator 510, the page buffer 504, the column decoder 506, the row decoder 508, the input/output circuit 516, etc., and is configured to control operations of each peripheral circuit. The control logic unit 512 may generate an operation signal in response to a command or control signal from the memory controller 106. The register 514 may be coupled to the control logic unit 512 and comprise a state register, a command register, and an address register, so as to store state information, a command operation code (OP code), and a command address for controlling the operations of each peripheral circuit. The input/output circuit 516 may be coupled to the control logic unit 512, and act as a control buffer to buffer and relay received control commands (e.g., from the host 108 the or memory controller 106) to the control logic unit 512 and state information received from the control logic unit 512 to the host 108 the or memory controller 106. The input/output circuit 516 may be also coupled to the page buffer 504 or the column decoder 506, and act as a data input/output interface and a data buffer to buffer and relay data to and from the memory cell array 501.

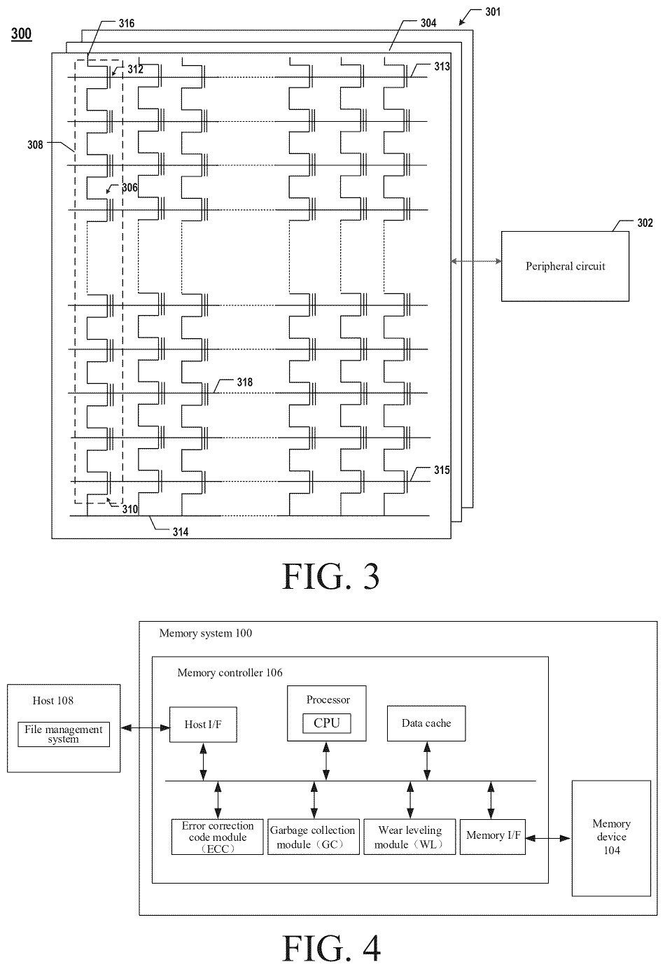

FIG. 3 illustrates a schematic circuit diagram of a memory device 300 (which may correspond to the memory device 104 in FIG. 1) comprising a peripheral circuit according to some aspects of the present disclosure. The memory device 300 may comprise a memory cell array 301 (which may correspond to the memory cell array 501 in FIG. 2) and a peripheral circuit 302 coupled to the memory cell array 301. The memory cell array 301 may comprise a plurality of memory blocks 304. In some implementations, each memory block 304 is a basic data unit for an crase operation, that is, all the memory cells 306 on the same memory block 304 are erased at the same time.

The memory cell array 301 may be a NAND flash memory cell array in which the memory cells 306 (NAND memory cells) are provided in the form of an array of memory cell strings 308 (NAND memory cell strings), with each memory cell string 308 extending vertically. In some implementations, each memory cell string 308 comprises a plurality of memory cells 306 coupled in series and stacked vertically. Each memory cell 306 may be either a floating gate memory cell that comprises a floating gate transistor, or a charge trap memory cell that comprises a charge trap transistor. In some implementations, each memory cell 306 may be a Single-level Cell (SLC) that has two possible memory states and may store one bit of data. For example, a first memory state “0” may correspond to a first voltage range, and a second memory state “1” may correspond to a second voltage range. In some implementations, each memory cell 306 may be a multiple level cell capable of storing more than a single bit of data in more than two memory states, e.g., a Multi-level Cell (MLC) storing two bits per cell, a Triple-level Cell (TLC) storing three bits per cell, or a Quad-level Cell (QLC) storing four bits per cell.

As shown in FIG. 3, each memory cell string 308 may comprise at least one source select transistor 310 at a source terminal thereof and at least one drain select transistor 312 at a drain transistor. The source select transistor 310 and the drain select transistor 312 may be configured to activate a selected memory cell string 308 during read and program operations. In some implementations, sources of memory cell strings 308 in the same memory block 304 are coupled through the same source line (SL) 314. According to some implementations, the drain select transistor 312 of each memory cell string 308 is coupled to a respective bit line 316. In some implementations, each memory cell string 308 is configured to be selected or unselected by applying a select voltage or an unselect voltage (e.g., 0 V) to the respective drain select transistor 312 via one or more drain select lines 313 and/or by applying a select voltage or an unselect voltage (e.g., 0 V) to the respective source select transistor 310 via one or more source select lines 315.

With reference to FIG. 1, according to some implementations, the memory controller 106 is coupled to the memory device 104 and the host 108, and configured to control the memory device 104. The memory controller 106 can manage data stored in the memory device 104 and communicate with the host 108. It may be understood that the memory controller 106 is configured to control the memory device 104 to perform the method of determining data hotness provided by any one of the examples of the present disclosure.

In some implementations, the memory controller 106 is designed for operating in a low duty-cycle environment, such as a Secure Digital (SD) card, a Compact Flash (CF) card, a Universal Serial Bus (USB) flash drive, or other media for use in electronic apparatuses, such as a personal computer, a digital camera, a mobile phone, etc.

In some implementations, the memory controller 106 is designed for operating in a high duty-cycle environment SSD or an embedded Multi-Media Card (eMMC) that is used as a data memory for a mobile apparatus, such as a smartphone, a tablet computer, a laptop computer, etc., and an enterprise memory array.

In some implementations, as shown in FIG. 4, the memory controller 106 may be further configured to manage various functions with respect to data stored or to be stored in the memory device 104, including, but not limited to, bad block management, garbage collection, and wear leveling, etc. The memory controller 106 may also perform any other suitable functions, e.g., formatting the memory device 104. The memory controller 106 may comprise a host interface (host I/F), a memory interface (memory I/F), a processor (CPU), an Error Correction Code (ECC) module, a garbage collection (GC) module, a wear leveling (WL) module, a data buffer, and a bus.

The host interface is a connection interface that connects the host 108 and the memory controller 106. The host interface allows the host 108 to communicate with the memory controller 106 according to a protocol, and receive read and write requests and other operation requests. The host interface may communicate with an external apparatus (e.g., the host 108) according to a communication protocol. For example, the host interface may communicate with the external apparatus through at least one of various interface protocols, such as a USB protocol, an MMC protocol, a Peripheral Component Interconnection (PCI) protocol, a PCI-Express (PCI-E) protocol, an Advanced Technology Attachment (ATA) protocol, a Serial-ATA protocol, a Parallel-ATA protocol, a Small Computer System Interface (SCSI) protocol, an Enhanced Small Disk Interface (ESDI) protocol, an Integrated Drive Electronics (IDE) protocol, a Firewire protocol, etc.

The memory interface is a connection interface between the memory controller 106 and the memory device 104, and the memory interface is configured to achieve transmission of data, commands, etc. between the memory controller 106 and the memory device 104.

The processor is configured to control the memory system 102 overall. The example operations performed by the memory controller are mainly performed and completed by the processor here. In some examples, the processor is, e.g., a central processing unit (CPU), a microcontroller unit (MCU), etc.

The error correction code (ECC) module may further comprise an encoding portion and a decoding portion. The encoding portion is configured to encode data to be stored, so as to obtain check data, and the decoding portion is configured to decode the check data to detect and correct possible errorcous data in a process of data transmission.

The garbage collection (GC) module is configured to, after a memory space of the memory device 104 reaches a certain threshold, read out valid data on some memory blocks, perform rewrite, and then label these memory blocks, so as to obtain new spare memory blocks. A general implementation of garbage collection may comprise three operations: selecting a source memory block with a small amount of valid data; finding the valid data from the source memory block; and writing the valid data to a target memory block. At this point, the entire data in the source memory block becomes invalid data, and the source memory block is labeled and may be used as a new spare memory block.

The wear leveling (WL) module is configured to keep wear (crase counts) of each memory blocks in the memory system 102 leveled through data statistics and algorithms. A general implementation of wear leveling may comprise two operations: selecting a source memory block in which cold data is located; and reading valid data on the source memory block and writing same to a memory block with a relatively large erase count. At this point, the valid data in the source memory block becomes invalid data, and the source memory block is labeled. The data buffer may be configured to buffer data.

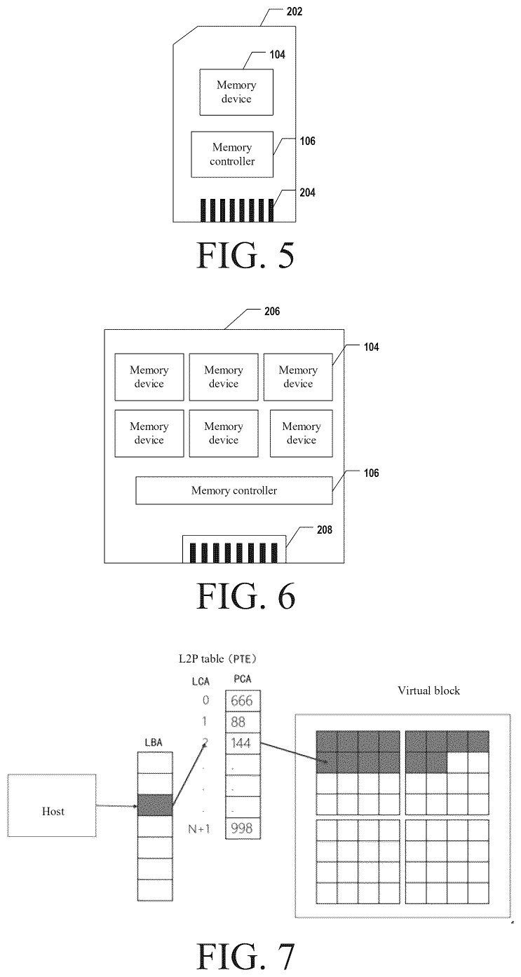

The memory controller 106 and the one or more memory devices 104 can be integrated into various types of storage apparatuses, e.g., be included in the same package (such as a Universal Flash Storage (UFS) package or an eMMC package). That is, the memory system 102 may be implemented and packaged into different types of end electronic products. In an example of a memory card shown in FIG. 5, the memory controller 106 and a single memory device 104 may be integrated into the memory card 202. The memory card 202 may include a PC card (Personal Computer Memory Card International Association, PCMCIA), a CF card, a Smart Media (SM) card, a memory stick, a Multimedia card (MMC, RS-MMC, MMCmicro), an SD card (SD, miniSD, microSD, SDHC), a UFS, etc. The memory card 202 may further comprise a memory card connector 204 coupling the memory card 202 with a host (e.g., the host 108 in FIG. 1).

In an example of a solid state drive shown in FIG. 6, the memory controller 106 and a plurality of memory devices 104 may be integrated into the solid state drive (SSD) 206. The solid state drive 206 may further comprise a solid state drive connector 208 coupling the solid state drive 206 with the host (e.g., the host 108 in FIG. 1). In some implementations, at least one of a storage capacity or an operation speed of the solid state drive 206 is greater than that of the memory card 202.

In some examples, the memory system 102 may have a Flash Translation Layer (FTL) in the memory controller 106, and may perform one or more command operations, internal operations, etc. through the FTL. For example, the memory controller 106 may control the memory device 104 through the FTL in response to a request from the host 108. At the same time, the memory controller 106 may perform the internal operations (e.g., a garbage collection operation, a read recycling operation, and a wear leveling operation) unrelated to the request from the host 108 through the FTL. The FTL may be operated by a processor of the memory controller 106. Accordingly, various operations of the FTL may be performed by the processor.

An important operation of the FTL comprises completing a conversion of a logical address space (e.g., a logical block address (LBA)) of the host 108 to a physical address space (e.g., a physical cluster address (PCA)) of the memory device 104. The memory system 102 writes a piece of user data into the memory device 104. The memory controller 106 calculates a logical block address (LBA) involved in a write request sent by the host 108, acquires a corresponding logical cluster address (LCA), then allocates a physical address space, such as a physical cluster address (PCA), to the piece of user data, stores the piece of user data in the corresponding physical cluster address (PCA), and records a logical cluster address to physical cluster address (PCA) mapping corresponding to the piece of user data, i.e., a logical cluster address to physical cluster address mapping relationship. When the host 108 reads the piece of data, the memory system 102 reads the piece of data from the memory device 104 based on the mapping relationship and then returns the data to the host 108.

When managing a physical memory space of the memory device 104, the memory controller 106 may divide the entire physical memory space of the memory device 104 evenly into a plurality of corresponding logical memory spaces to perform cover expression, the plurality of logical memory spaces may cover the entire physical memory space of the memory device 104, and each logical memory space has a corresponding logical cluster address (LCA). In some examples, each logical memory space may correspond to a 4 K memory space. The memory system 102 may maintain a logical cluster address to physical cluster address mapping table (logical-to-physical mapping table, L2P mapping table) internally, so as to perform conversion between a logical block address recognized by the host and a physical cluster address of the memory device, wherein the L2P mapping table comprises all logical cluster address to physical cluster address mapping relationships. As shown in FIG. 7, a physical cluster address (PCA) of the memory device 104 to which a logical block address is mapped may be determined based on the L2P mapping table.

As shown in FIG. 1 and FIG. 4, the memory device 104 is configured to store user data provided by a file management system, and the file management system is able to recognize a logical address (e.g., logical block address (LBA)) of the user data. As the memory device is a physical address (e.g., physical cluster address (PCA)), the memory controller 106 is required to implement a conversion between the logical address and the physical address, i.e., managing the logical-to-physical mapping table (L2P mapping table). In order to reduce a read latency of the host, the L2P mapping table is preferentially placed in an internal storage (e.g., the data cache in FIG. 4) of the memory controller 106 or in a cache communicating with the memory controller 106. In an example, the internal storage of the memory controller 106 or the cache communicating with the memory controller 106 may include a volatile memory device, for example, including, but not limited to, a Static Random Access Memory (SRAM), a Dynamic Random Access Memory (DRAM), etc.

Several methods may be used to store and maintain the L2P mapping table. One of the methods is a single-level direct L2P mapping solution, which may contain mapping information used for data in the entire memory device. Therefore, the single-level direct page mapping solution requires a large amount of memory space (1 GB of data corresponds to an L2P mapping table with a storage on the order of 1-2 MB) to store the L2P mapping table, which is challenging for a high-capacity memory device.

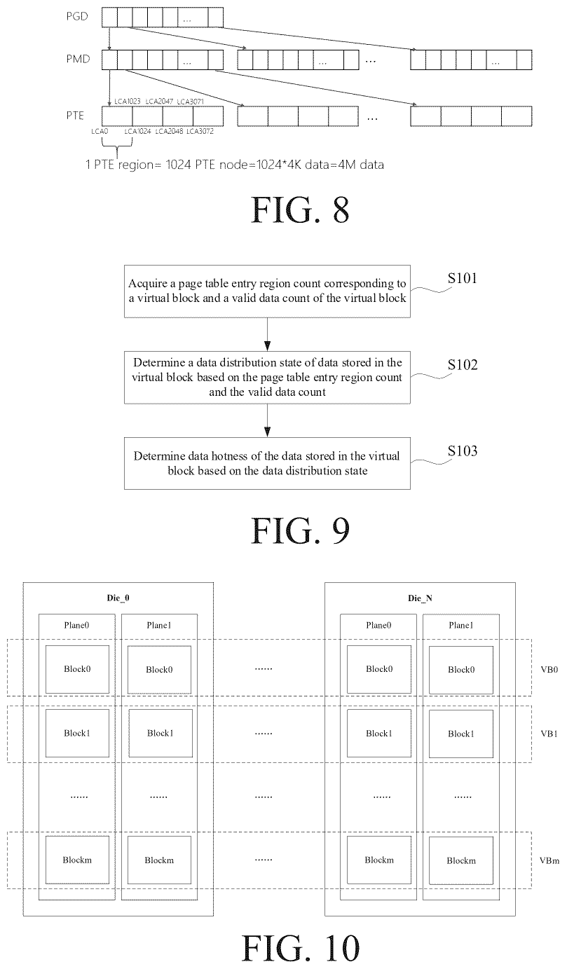

Another method used to store and maintain the L2P mapping table is a multi-level mapping solution, which is illustrated here using a three-level mapping solution as an example. As shown in FIG. 8, a first-level mapping table may be referred to as a page global directory (PGD) or page directory, which stores physical addresses (e.g., physical cluster address (PCA)) of second-level mapping tables, and each entry in the first-level mapping table points to a second-level mapping table. A second-level mapping table may be referred to as a page middle directory (PMD), which stores physical addresses (e.g., physical cluster address (PCA)) of third-level mapping tables, and each mapping in the second-level mapping table points to a third-level mapping table. The third-level mapping table may be referred to as a page table entry (PTE), which stores physical addresses (e.g., physical cluster address (PCA)) where data is located.

The memory controller 106 divides the entire physical memory space of the memory device 104 evenly into the plurality of corresponding logical memory spaces to perform the cover expression, and allocates a corresponding logical cluster address (LCA) to each logical memory space. The memory controller 106 may number a plurality of logical cluster addresses (LCAs) from 0 (LCA0) and arrange them in the page table entry from LCA0, with each logical cluster address (LCA) having a fixed location in the page table entry. Referring to FIG. 8, each page table entry comprises 4 page table entry regions (PTE regions), each page table entry region may comprise 1024 nodes, and each node may comprise a physical cluster address (PCA) mapping to a logical cluster address (LCA) and corresponds to a 4 K memory space. Accordingly, each page table entry region may correspond to 4 M of user data, and each page table entry may correspond to 16 M of user data.

In the multi-level mapping solution, the first-level mapping table may be stored in an internal storage of the memory controller 106, that is, the first-level mapping table is permanently resident in the internal storage of the memory controller 106, and some of the other levels of mapping tables are stored in the internal storage of the memory device 106. When an L2P mapping relationship corresponding to a logical block address involved in a read request of the host 108 is not in the internal storage of the memory controller 106, the memory controller 106 is required to first read the corresponding L2P mapping relationship from the memory device 104 to the internal storage of the memory controller 106, and then perform the respective read operation of the read request of the host 108.

In practical applications, with the elapse of time, increasingly more historical data is accumulated in the memory system, and in order to save data storage costs and improve storage performance, it is required to divide the data into hot data and cold data, so as to sink the cold data effectively and elevate the hot data. The host 108 can add labels to the hot and cold data to differentiate between the hot and cold data, while the host 108 and the memory system 102 both require new functions and interfaces for proper data classification and management. However, if the memory system 102 fails to accurately obtain the labels added by the host 108 regarding hot and cold data, the migration of data within the memory system 102 may be affected. For example, the cold data may be migrated frequently, affecting the performance of the memory system 102, increasing write amplification of the memory system 102, and reducing Total Bytes Written (TBW) of the memory system 102.

Accordingly, the technical solution of the present disclosure provides a method of determining data hotness, which is applied to the memory controller 106 in the memory system 102, wherein a file is continuously or randomly involved into a judgement of the hot and cold data to determine coldness and hotness of the data, so that the cold data is sunk better, thereby reducing the migrations of the cold data to a certain extent. On the one hand, the performance of the memory system can be improved, and on the other hand, the write amplification caused during garbage collection of the memory system can be reduced, increasing a service life and total bytes written of a memory apparatus.

FIG. 9 is a flow diagram of the method of determining data hotness according to examples of the present disclosure. It is to be noted that operations illustrated in the flow diagram of the drawings may be performed in a system such as a set of computer-executable instructions, and although a logical sequence is illustrated in the flow diagram, in some cases the operations illustrated or described may be performed in an order different from that herein. As shown in FIG. 9, the flow comprises the following operations.

Operation S101, a page table entry region count corresponding to a virtual block and a valid data count of the virtual block are acquired.

When the memory controller 106 manages and controls the memory device 104, in order to improve the performance of the memory system 102, there are usually a multiplane synchronous operation mode and a multiplane asynchronous operation mode to implement synchronous/asynchronous operations on a plurality of planes, and the memory controller 106 manages and controls the memory device 104 with a virtual memory block (also referred to as a virtual block (VB)), the virtual block comprising at least one memory block. In some examples, with reference to FIG. 10, the memory device 104 comprises a plurality of memory dies (e.g., N+1 dies), wherein each memory die comprises a plurality of memory planes (e.g., 2 planes), each memory plane comprises a plurality of memory blocks (e.g., m+1 blocks), and memory blocks having the same number in different memory planes of different memory dies constitute a virtual block (VB). The constitution of the virtual block (VB) here is an example and does not preclude other patterns.

Data stored in each memory block has a corresponding logical address, and a corresponding memory location in a page table entry for each memory block contained in the virtual block can be determined through the logical address. The page table entry is used to store a mapping relationship between logical addresses and physical addresses, and is divided into different page table entry regions. A page table entry region occupied by each memory block contained in the virtual block can be determined according to the corresponding location of each memory block in the page table entry. The page table entry region count corresponding to the virtual block may be obtained by counting the number of page table entry regions in an occupied state.

In an example implementation, if data written to a virtual block has consecutive logical addresses, and if each page table entry region corresponds to a data storage volume of 4 MB, then it can be determined that a page table entry region count required to write 96 MB of file data consecutively is PTE region count=96 MB/4 MB=24. If data written to a virtual block is random and corresponds to different page table entry regions, and each page table entry region corresponds to a data storage volume of 4 K, then a page table entry region count required to write 96 MB of file data randomly is PTE region count=98304 K/4 K=24576. Accordingly, the consecutiveness of the data stored in the virtual block can be determined based on the page table entry region count.

The valid data count is the number of pieces of valid data recorded in the virtual block. In an implementation, one page table entry region has 1024 page table entry nodes, and each page table entry node corresponds to 4 K of data. The valid data in the virtual block is in unit of a 4 K data volume, and the valid data count is the number of pieces of 4 K valid data recorded in the virtual block.

Operation S102, a data distribution state of data stored in the virtual block is determined based on the page table entry region count and the valid data count.

The data distribution state is used to represent a discrete degree of the distribution of the data on the virtual block. For example, when the LBAs of the data are consecutive, it indicates that the data distribution is consecutive, i.e., the distribution state of the data on the virtual block is centralized; and when the LBAs of the data is random, it indicates that the data distribution is inconsecutive, i.e., the distribution state of the data on the virtual block is discrete.

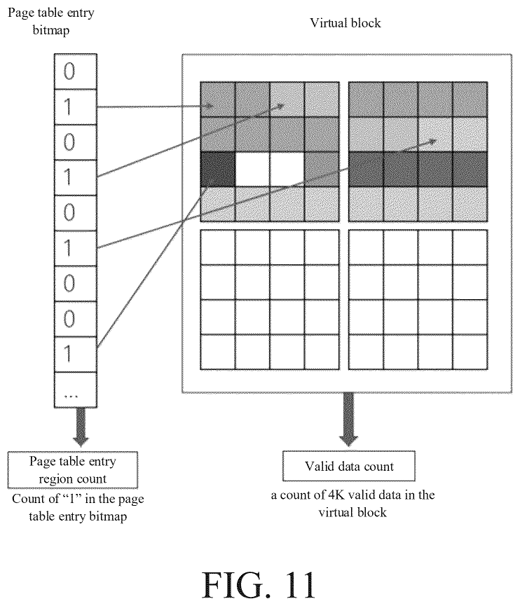

In an implementation, as shown in FIG. 11, the data distribution state may be represented through a relative relationship between the page table entry region count and the valid data count, whereby the consecutiveness of the data stored in the virtual block is determined through the relative relationship. The smaller page table entry region count compared with the valid data count denotes the more consecutive distribution of the data in the virtual block; on the contrary, the larger page table entry region count denotes the more discrete distribution of the data in the virtual block.

Operation S103, data hotness of the data stored in the virtual block is determined based on the data distribution state.

The data hotness represents an access frequency and a use frequency for the data in the virtual block. In an example, the hot data refers to data that is frequently accessed and used, e.g., user interaction data in social media platforms, real-time transaction data, etc.; while the cold data refers to data that is not accessed and used for a long period of time, e.g., old backup data, previous log data, etc.

A distribution location of the data in the virtual block can be determined based on the data distribution state, and whether the data distribution in the virtual block is consecutive or discrete can be determined according to the distribution location. As such, the discrete degree of the data stored in the virtual block can be determined based on the data distribution state, wherein a higher discrete degree denotes a higher degree of the data hotness, and a lower discrete degree indicates a lower degree of the data hotness.

In the method of determining data hotness provided in this example, the data distribution state of the data stored in the virtual block is represented by the ratio between the page table entry region count and the valid data count, and the data distribution state is involved in the judgement of the hot and cold data. As such, the data hotness may be judged according to the page table entry region count, so as to facilitate separating the cold data from the hot data according to the data hotness, so that the cold data can be sunk better to reduce the migrations of the cold data, thereby reducing write amplification caused by garbage collection and ensuring the storage performance of the memory system as well as an amount of data that can be written to the memory system.

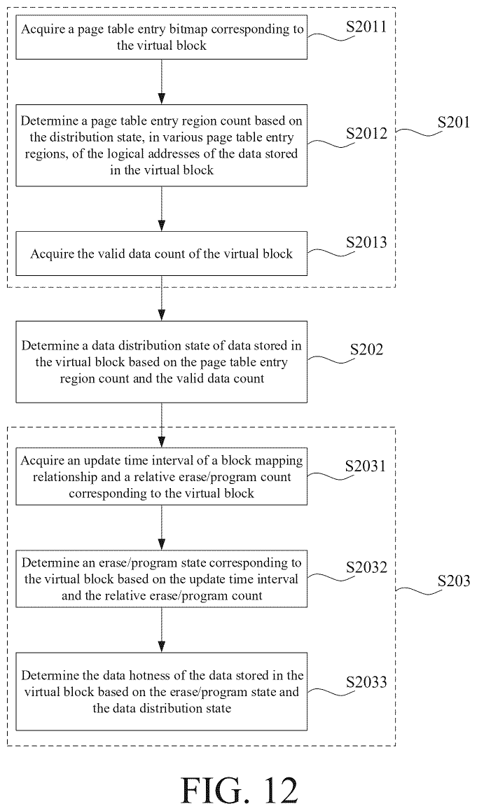

Another method of determining data hotness that is applicable to the memory controller 106 is provided in this example. FIG. 12 is a flow diagram of the method of determining data hotness according to examples of the present disclosure. As shown in FIG. 12, the flow comprises the following operations.

Operation S201, a page table entry region count corresponding to a virtual block and a valid data count of the virtual block are acquired.

The virtual block comprises at least one memory block in the memory device.

In an implementation, operation S201 may comprise:

Operation S2011, a page table entry bitmap corresponding to the virtual block is acquired.

The page table entry bitmap represents a distribution state, in various page table entry regions, of logical addresses of the data stored in the virtual block.

The page table entry bitmap is used to record a memory location, in the page table entry region, of each piece of data in the virtual block, i.e., determining the distribution state of the data in the page table entry regions through the logical addresses of the data. In an implementation, if each page table entry region comprises 1024 page table entry nodes, and each page table entry node corresponds to 4 K of data, and each page table entry region is numbered to form a page table entry index of each page table entry region, for example, a page table entry region (the first page table entry region) with a page table entry index 0 corresponds to logical cluster addresses 0-1023, and a page table entry region with a page table entry index 1 corresponds to logical cluster addresses 1024-2047.

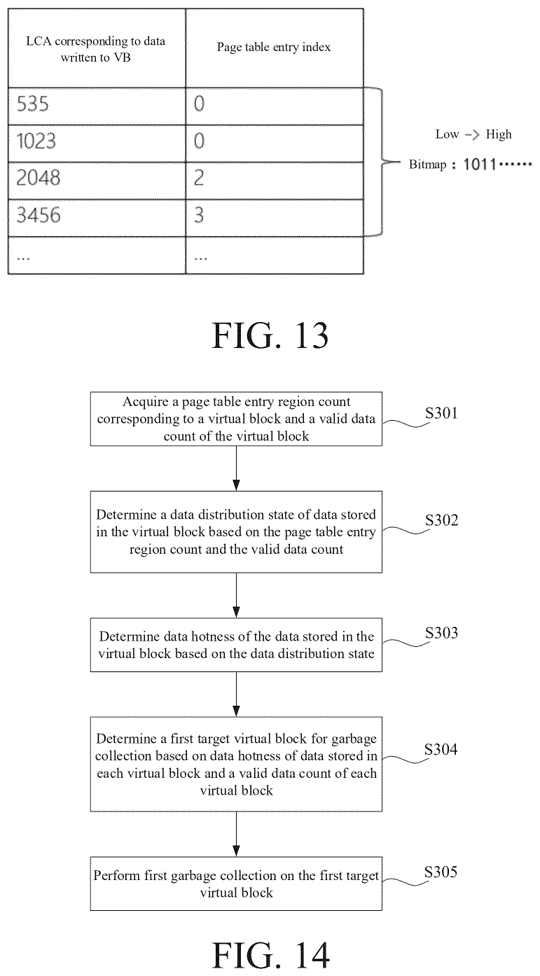

In the page table entry bitmap shown in FIG. 13, a logical address 535 corresponds to the first page table entry region with the page table entry index 0; a logical address 1023 corresponds to the first page table entry region with the page table entry index 0; a logical address 2048 corresponds to the third page table entry region with a page table entry index 2; and a logical address 3456 corresponds to the fourth page table entry region with a page table entry index 3, etc. On this basis, a correspondence between the logical addresses of the data stored in the virtual block and the page table entry regions can be determined, thereby obtaining the page table entry bitmap: 1011.

Operation S2012, the page table entry region count is determined based on the distribution state, in all the page table entry regions, of the logical addresses of the data stored in the virtual block.

The page table entry region count denotes the number of page table entry regions having corresponding data, and as can be seen from above, the page table entry region corresponding to each piece of data can be determined according to the logical address of each piece of data. A page table entry region having corresponding data and a page table entry region having no corresponding data have different data identifiers in the page table entry bitmap, and the page table entry region count can be obtained by counting data identifiers in the page table entry bitmap that are used to represent the presence of corresponding data.

As shown in FIG. 13, the page table entry region having corresponding data is represented by “1” in the page table entry bitmap, and the page table entry region having no corresponding data is represented by “0” in the page table entry bitmap. As a result, the page table entry region count can be obtained by counting “1” in the page table entry bitmap.

Operation S2013, the valid data count of the virtual block is acquired. For a detailed description, reference may be made to the relevant description corresponding to the above method examples, which is no longer repeated here.

In the method of determining data hotness provided in this example, the respective page table entry region count is determined by detecting the distribution state, in the page table entry regions, of the logical addresses of the data stored in the virtual block, so as to facilitate determining the consecutiveness of the data distribution on the virtual block based on the page table entry region count.

Operation S202, a data distribution state of data stored in the virtual block is determined based on the page table entry region count and the valid data count.

In an implementation, the above operation S202 may comprise: determining a second ratio between the page table entry region count and the valid data count, and using the second ratio to represent the data distribution state.

The second ratio is a ratio of the page table entry region count to the valid data count, and the second ratio is used as a distribution parameter value representing the data distribution state, i.e.:

$$r = \frac{PTE region count}{Valid data count}$$

wherein r denotes the second ratio, i.e., a degree of randomness of the stored data; PTE region count represents the page table entry region count; and Valid data count represents the valid data count.

As can be seen from the way to determine the second ratio, in the cases of the same valid data count, when the page table entry region count is larger, the data distribution state is more discrete at this time, and accordingly the second ratio is larger; in the cases of the same page table entry region count, when the valid data count is larger, the data distribution state is more centralized at this time, and accordingly the second ratio is smaller. It thus can be seen that the smaller second ratio represents the more centralized data distribution; and the larger second ratio represents the more discrete data distribution state.

As such, the consecutiveness of the logical addresses of the data in the virtual block can be determined based on the page table entry region count, and the data distribution state can be determined based on the valid data count, so as to introduce a random distribution indicator of the data as an indicator for judging the hot and cold data, thereby improving the accuracy of determining the cold data and the hot data.

Operation S203, data hotness of the data stored in the virtual block is determined based on the data distribution state.

In an implementation, operation S203 may comprise:

Operation S2031, an update time interval of a block mapping relationship and a relative erase/program count corresponding to the virtual block are acquired.

The block mapping relationship corresponding to the virtual block is a relationship that maps the virtual block to a memory block. Since the memory device 104 usually processes data in unit of a memory block with fixed size, and the virtual block contains one or more memory blocks, in order to correspond the virtual block to the memory block, the block mapping relationship is used to realize the mapping between the virtual block and the memory block. The block mapping relationship may be represented by the L2P mapping table.

The update time interval denotes a time interval for updating or modifying the block mapping relationship, which may be determined by calculating a difference between time of a last modification of the mapping relationship and current time. In an implementation, the operation of acquiring the update time interval of the mapping relationship corresponding to the virtual block may comprise:

Operation a1, latest update time of the block mapping relationship of the virtual block is acquired.

Operation a2, a time difference between the latest update time and current time is determined, and the time difference is determined as the update time interval.

The latest update time denotes update time of the block mapping relationship closest to the current time, which can be determined through a recorded timestamp. Whenever an update of the block mapping relationship occurs, a timestamp may be updated to reflect an update time, wherein the update time is time when the update of the block mapping relationship is completed, i.e., the update time of the block mapping relationship is recorded only after updates to all pieces of data corresponding to the block mapping relationship are completed. For example, when an update of the block mapping relationship occurs with an update start time T, data update time of the block mapping relationship is recorded respectively to determine update completion time of each piece of data during this update of the block mapping relationship. Since one time of update of the block mapping relationship may involve multiple pieces of data and the update completion time of each piece of data may be different, update completion time T1 of the last piece of data may be determined, and T1 is used as the update time of the block mapping relationship during this update.

The current time is compared with the latest update time, the time difference between the latest update time and current time is calculated, and the time difference is determined as the update time interval.

In the above implementation, a respective erase/program state is determined based on the update time interval of the block mapping relationship and the relative crase/program count, and the crasc/program state is involved in a process of judging the hot and cold data, thereby facilitating determining and determining the cold data and the hot data based on the erase/program state and further improving the accuracy of the judging the hot and cold data.

The relative erase/program count denotes a relative value of erase/program counts of the current virtual block and an idle virtual block, which can be determined by calculating a difference between the erase/program count of the current virtual block and a minimum erase/program count of the idle virtual block. In an implementation, the operation of acquiring the relative erase/program count corresponding to the virtual block may comprise:

Operation b1, a first erase/program count corresponding to the virtual block and a second crase/program count of another virtual block currently in an unused state is acquired.

Operation b2, the relative erase/program count is determined based on a difference between the first erase/program count and the second erase/program count.

The erase/program count denotes the number of times the memory block has been erased. The first erase/program count denotes the erase/program count in the current virtual block, and the second erase/program count represents the crase/program count in the virtual block in the unused state (i.e., idle state). Since there may be a plurality of virtual blocks in the idle state, accordingly, there may be a plurality of second erase/program counts obtained.

In determining of the relative crase/program count, the first erase/program count may be compared with various second erase/program counts sequentially, so as to determine differences between the first erase/program count and various second crase/program counts and select a maximum difference therefrom, and the maximum difference is determined as the relative crase/program count.

Alternatively, a minimum second erase/program count is first selected from the plurality of second erase/program counts, and then the relative erase/program count is obtained based on a difference between the first erase/program count and the minimum second erase/program count.

The crase/program count represents the number of data changes in the virtual block. By observing the relative erase/program count, a relative age of the data stored on the virtual block can be learned approximately. That is, a larger relative erase/program count denotes a lower data update frequency, and a smaller relative erase/program count denotes a higher data update frequency.

In the memory system 102, a larger erase/program count indicates that the virtual block may have much wear and is used to store the cold data to reduce data updates; a smaller crase/program count indicates that the virtual block has little wear and is used to store the hot data or data that is written just now. Therefore, the use of the relative erase/program count as an indicator for measuring an aging degree of the data in conjunction the relative crase/program count for learning of the relative age of the data in the virtual block can accurately reflect an update frequency of the data stored in the virtual block, thereby facilitating subsequent accurate evaluation of freshness of the data stored in the virtual block.

Operation S2032, an crase/program state corresponding to the virtual block is determined based on the update time interval and the relative erase/program count.

The erase/program state is used to represent an crase/program state corresponding to the current virtual block, and a product value of the update time interval and the relative crase/program count is used as an crase/program parameter value representing the crase/program state. For example, if the update time interval is represented by age and the relative erase/program count is represented by EC, then the erase/program state corresponding to the virtual block may be represented by age×EC.

Operation S2033, the data hotness of the data stored in the virtual block is determined based on the erase/program state and the data distribution state.

The data distribution state can be represented by a calculated distribution parameter value (i.e., the ratio between the page table entry region count and the valid data count). After the crase/program parameter value (i.e., the product value of the update time interval and the relative erase/program count) used to represent the crase/program state is determined, the data hotness of the data stored on the virtual block may be predicted based on the crase/program parameter value in conjunction with the page table entry region count and the valid data count, and specifically determined in the following manner:

coldrate=f(E,r)
wherein coldrate denotes the data hotness of the data; E denotes the erase/program parameter value representing the crase/program state; r denotes the distribution parameter value representing the data distribution state; and f( ) denotes a function expression for determining the data hotness.

In the method of determining data hotness provided in this example, the crase/program state of the virtual block is determined based on the relative erase/program count and the update time interval, and the data hotness is evaluated according to the crase/program state and the data distribution state, thereby implementing comprehensive evaluation of the data hotness of the data from a plurality of dimensions and improving the accuracy of judging the data hotness.

In some example implementations, the above operation S2023 may comprise:

Operation c1, the data distribution state is adjusted according to a preset adjustment coefficient to generate an adjusted data distribution state.

Operation c2, the data hotness of the data stored in the virtual block is determined based on the crase/program state and the adjusted data distribution state.

The preset adjustment coefficient is a preset parameter for adjusting the data distribution state, the preset adjustment coefficient may be adjusted according to different scenarios, and a value of the preset adjustment coefficient is not defined particularly here.

The parameter value r used to represent the data distribution state is adjusted through the preset adjustment coefficient, so as to obtain an adjusted parameter value. Then, the data hotness of the data is determined according to the crase/program state and the adjusted data distribution state with an expression as follows:

coldrate=f(E,h(r,n))
wherein coldrate denotes the data hotness of the data; E denotes the crase/program parameter value representing the crase/program state; r denotes the distribution parameter value representing the data distribution state; n represents the preset adjustment coefficient; f( ) denotes a function expression for determining the data hotness; and h( ) denotes a function expression for determining an adjusted distribution parameter value.

In the above implementation, the data distribution state is adjusted according to the preset adjustment coefficient, so as to facilitate determining different data distribution states based on different scenarios, thereby achieving the calculation of data hotness in different scenarios and improving the accuracy of determining the data hotness.

In some example implementations, the above operation c2 may comprise determining a first ratio between the erase/program state and the adjusted data distribution state, the first ratio to represent the data hotness of the data stored in the virtual block.

In an implementation, the data hotness of the data is determined according to the crase/program state and the adjusted data distribution state with an expression as follows:

$$coldrate = \frac{age * EC}{h ( r , n )}$$

wherein coldrate denotes the data hotness of the data; age denotes the update time interval; EC denotes the relative erase/program count; r denotes the distribution parameter value representing the data distribution state; n denotes the preset adjustment coefficient; and h( ) denotes a function expression for determining the adjusted distribution parameter value.

wherein a larger value of coldrate denotes a lower update frequency of the data stored in the virtual block, in which case the data is older, i.e., the data is colder.

In an example implementation, the adjusted distribution parameter value r+n is obtained by adding the preset adjustment coefficient n to the distribution parameter value r, and r+n is used to represent the adjusted data distribution state, whereby an expression for the data hotness may be obtained as follows:

$$coldrate = \frac{age * EC}{r + n}$$

wherein coldrate denotes the data hotness of the data; age denotes the update time interval; EC denotes the relative erase/program count; r denotes the distribution parameter value representing the data distribution state; and n denotes the preset adjustment coefficient.

In the method of determining data hotness provided in this example, the data hotness of the data stored in the virtual block is represented by the ratio between the erase/program state and the adjusted data distribution state, so as to judge a cold-hot relationship of the data based on a plurality of dimensions including the update time interval, the relative erase/program count, and the data distribution state, thereby ensuring the accuracy of judging the hot and cold data in various scenarios to the maximum extent.

Yet another method of determining data hotness that is applicable to the memory controller 106 is provided in this example. FIG. 14 is a flow diagram of the method of determining data hotness according to examples of the present disclosure. As shown in FIG. 14, the flow comprises the following operations.

Operation S301, a page table entry region count corresponding to a virtual block and a valid data count of the virtual block are acquired. The virtual block comprises at least one memory block in the memory device. For a detailed description, reference may be made to the relevant description corresponding to the above method examples, which is no longer repeated here.

Operation S302, a data distribution state of data stored in the virtual block is determined based on the page table entry region count and the valid data count. For a detailed description, reference may be made to the relevant description corresponding to the above method examples, which is no longer repeated here.

Operation S303, data hotness of the data stored in the virtual block is determined based on the data distribution state. For a detailed description, reference may be made to the relevant description corresponding to the above method examples, which is no longer repeated here.

Operation S304, a first target virtual block for garbage collection is determined based on data hotness of data stored in each virtual block and a valid data count of each virtual block.

In an implementation, the first target virtual block is a virtual block with high collection value, that is, the first target virtual block stores a large amount of cold data and has a small valid data count. The collection value is high. Virtual blocks are sorted according to the data hotness of the data stored in each of the virtual blocks, so as to select a virtual block having more cold data therefrom. Virtual blocks are sorted according to the valid data count of each of the virtual blocks, so as to select a virtual block having a minimum valid data count therefrom. As such, collection value of each virtual block is evaluated based on a data volume of the cold data and the valid data count, so as to determine the first target virtual block with high collection value from virtual blocks.

In some example implementations, the above operation S304 may comprise:

Operation d1, a data storage volume of each virtual block is acquired. The data storage volume is a capacity of the virtual block to store data.

Operation d2, a valid data proportion of each virtual block is determined based on the valid data count and the data storage volume corresponding to each virtual block.

A valid data volume is a data volume of the valid data stored in the virtual block currently, which is calculated by a product of a unit storage volume of the valid data and the valid data count. For example, the unit storage volume of the valid data being 4 K indicates that the valid data in the virtual block is in unit of a 4 K data volume.

In an implementation, the valid data volume of data stored in the virtual block is obtained by counting valid data volumes in each the memory block and adding the valid data volume of each memory block.

A ratio between the valid data volume and the data storage volume corresponding to the virtual block is calculated based on the valid data volume and the data storage volume corresponding to the virtual block, so as to obtain the proportion of the valid data in the virtual block, i.e., the valid data proportion of the virtual block.

Operation d3, a collection parameter value corresponding to each virtual block is determined according to the valid data proportion and the data hotness.

The collection parameter value is used to represent the collection value of the virtual block, wherein a larger collection parameter value represents that the virtual block is of a higher value to collect. An example way of determining the collection parameter value based on the valid data proportion and the data hotness is as follows:

$$cost\_benefit = \frac{1 - u}{*} * coldrate$$

wherein u denotes the valid data proportion; 1−u may be used to represent a benefit of the garbage collection on the virtual block; 2u denotes a cost of the garbage collection on the virtual block; cost_benefit denotes the collection parameter value; and coldrate denotes the data hotness.

Operation d4, the first target virtual block for garbage collection is determined from a plurality of virtual blocks based on the collection parameter value.

Collection parameter values of various virtual blocks are compared with each other to obtain a comparison result of the collection parameter values. A virtual block with a relatively large collection parameter value is determined from the plurality of virtual blocks based on the comparison result of the collection parameter values, and the virtual block with the large collection parameter value is determined as the first target virtual block.

In an implementation, the larger collection parameter value represents a higher collection value of first target virtual block.

In the above implementation, the collection value of each virtual block is determined based on the valid data proportion and the data hotness, so as to select the target virtual block with the highest collection value, thereby reducing migrations of the cold data and increasing the collection value of the virtual block.

Operation S305, first garbage collection is performed on the first target virtual block.

The first garbage collection denotes background garbage collection for data stored in the first target virtual block. The first garbage collection may be scheduled as being performed when system resources are sufficient, so as to reduce the impact of the garbage collection on other operations such as read, write, erase, etc.

In the method of determining data hotness provided in this example, after the first target virtual block is determined, valid data stored in the first target virtual block is migrated to reduce the amount of migrated valid data, and the first target virtual block from which the valid data is migrated is labeled.

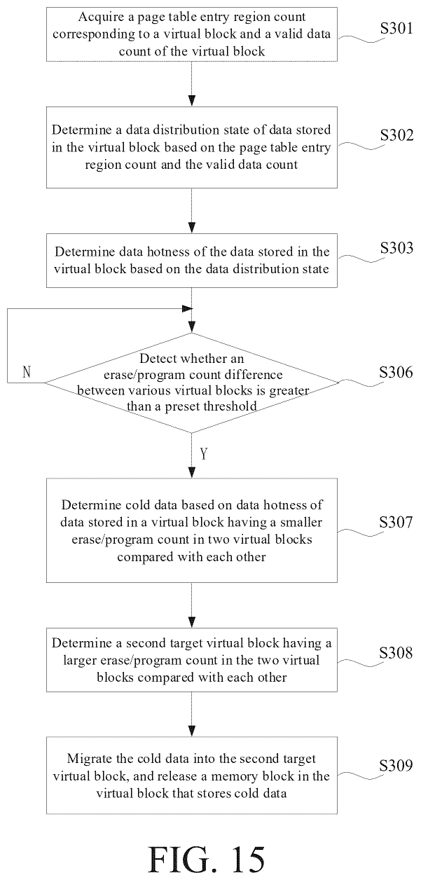

In some example implementations, as shown in FIG. 15, on the basis of operation S301 to operation S303, the above method may further comprise:

Operation S306, whether an erase/program count difference between various virtual blocks is greater than a preset threshold is detected.

The preset threshold is a preset maximum crase/program count difference allowed. By acquiring the erase/program counts of various the virtual blocks, an erase/program count difference between each two virtual blocks is calculated respectively, and the erase/program count difference is compared with the preset threshold value to determine whether the crase/program count difference between virtual blocks is greater than the preset threshold.

When the erase/program count difference is greater than the preset threshold, operation S307 is performed, or otherwise operation S306 continues to be performed.

Operation S307, cold data is determined based on data hotness of data stored in a virtual block having a smaller crase/program count in two virtual blocks compared with each other.

When the erase/program count difference is greater than the preset threshold, it indicates that data erasure among virtual blocks is unleveled, and at this time, in order to level the data erase counts between various virtual blocks, it is required to level and adjust the crase/program counts of the virtual blocks.

In an implementation, when the erase/program count difference is greater than the preset threshold, the virtual block having a smaller erase/program count in the two virtual blocks compared with each other may be determined according to the erase/program count difference, and the data hotness of the data stored in the virtual block having the smaller erase/program count is evaluated to determine the cold data.

Operation S308, a second target virtual block having a larger erase/program count in the two virtual blocks compared with each other is determined. An erase/program count of the second target virtual block is greater than an crase/program count of the virtual block where the cold data is located.

When the crase/program count difference is greater than the preset threshold, in order to level the data erase counts between various virtual blocks, at this time, the virtual block having a larger erase/program count in the two virtual blocks compared with each other may be determined according to the erase/program count difference, and the virtual block having a larger erase/program count is determined as the second target virtual block. An erase/program count of the second target virtual block is greater than an erase/program count of the virtual block where the cold data is located. As such, the cold data in the virtual block having a small erase/program count may be migrated into the second target virtual block having a large erase/program count, thereby leveling crase/program counts of the entire memory.

Operation S309, the cold data is migrated into the second target virtual block, and a memory block in the virtual block that stores cold data is released.

The virtual block having a small erasc/program count where the cold data is located is used as the virtual block requiring a data migration, and the second target virtual block having a large crase/program count is used as a target virtual block for the data migration. Then, the cold data is copied piece by piece to the second target virtual block to implement a migration of the cold data. After the migration of the cold data, the memory block where the cold data is located is released and re-added to a pool of available blocks of the virtual block, so that the original memory block can be reused to store new data.

In the method of determining data hotness provided in this example, by determining the cold data stored in the virtual block having a small erase/program count, and migrating the cold data into the second target virtual block having a large crase/program count, the leveling of the crase/program counts of the virtual blocks is implemented, thereby ensuring a data migration effect and the operation stability of a storage system.

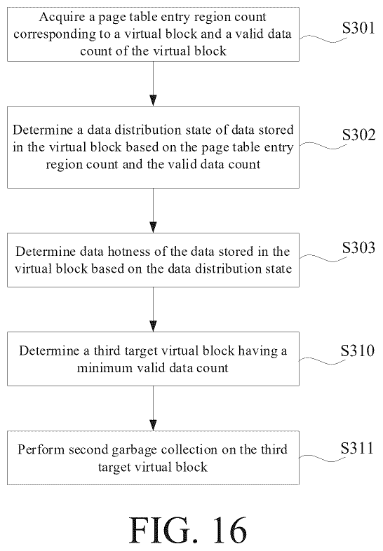

In some example implementations, as shown in FIG. 16, on the basis of operation S301 to operation S303, the above method may further comprise:

Operation S310, a third target virtual block having a minimum valid data count is determined.

In an implementation, the valid data count of the data stored in the virtual block is obtained by counting valid data counts in each memory block and adding up the valid data counts of each memory block.

The valid data counts corresponding to virtual blocks are compared with each other, to obtain a comparison result of the valid data counts of virtual blocks. The virtual block having a minimum valid data count may be determined based on the comparison result of the valid data counts, and the virtual block having a minimum valid data count is determined as the third target virtual block.

Operation S311, second garbage collection is performed on the third target virtual block.

The second garbage collection denotes foreground garbage collection for data stored in the third target virtual block. The second garbage collection refers to a garbage collection operation during a write operation performed in response to a write request sent by the host, which is performed when insufficient internal storage or garbage data accumulation is detected.

The foreground garbage collection occupies some resources and time and therefore may cause a suspension of the write operation. In order to reduce the impact of a second garbage collection process on the write operation, a greedy algorithm may be used to select the virtual block having the minimum valid data count as the third target virtual block for garbage collection, so as to ensure the foreground collection efficiency of the virtual block and minimize the impact of the foreground garbage collection process on the write operation.

In the method of determining data hotness provided in this example, the virtual block having the minimum valid data count may be determined by filtering the virtual blocks based on the valid data counts, and the foreground collection is performed on the virtual block having the minimum valid data count, thereby improving the foreground collection efficiency of the virtual block and reducing the impact of the data migration on the operation of a foreground application.

Examples of the present disclosure also provide a computer readable storage medium, wherein the above method according to the examples of the present disclosure may be implemented in hardware, firmware, or implemented as being able to be recorded on a storage medium, or implemented as computer codes that are originally stored on a remote storage medium or non-transitory machine readable storage medium downloaded over a network and that are to be stored on a local storage medium, such that the method described here may be stored and processed by such software on a storage medium using a general purpose computer, a dedicated processor, or programmable or dedicated hardware. The storage medium may be a diskette, an optical disk, a Read-Only Memory, a Random Access Memory, a Flash Memory, a Hard Disk Drive, or a solid state drive, etc.; and the storage medium may further include a combination of the above types of memories. It may be understood that the computer, processor, microprocessor controller, or programmable hardware comprises a storage component that can store or receive software or computer codes, and when the software or computer codes are accessed and executed by the computer, processor, or hardware, the method illustrated in the above examples is implemented.

In view of this, examples of the present disclosure provide a method of determining data hotness, a device, a storage apparatus, and a storage medium, so as to solve the problem of an accumulation of historical data that affects storage performance.

In a first aspect, examples of the present disclosure provide a method of determining data hotness, comprising: acquiring a page table entry region count corresponding to a virtual block and a valid data count of the virtual block, wherein the virtual block comprises at least one memory block in a memory device; determining a data distribution state of data stored in the virtual block based on the page table entry region count and the valid data count; and determining data hotness of the data stored in the virtual block based on the data distribution state.

In a second aspect, examples of the present disclosure provide a memory controller, comprising: a cache and a processor, wherein the cache and the processor are communicatively connected with each other, the cache has computer instructions stored therein, and the processor executes the computer instructions to implement the method of determining data hotness in the above first aspect or in any of its corresponding implementations.

In a third aspect, examples of the present disclosure provide a memory system, comprising: a memory device comprising a memory array, the memory array comprising a plurality of memory blocks; and a memory controller coupled with the memory device and configured to: acquire a page table entry region count corresponding to a virtual block and a valid data count of the virtual block, wherein the virtual block comprises at least one of the memory blocks; determine a data distribution state of the virtual block based on the page table entry region count and the valid data count; and determine data hotness of data stored in the virtual block based on the data distribution state.

In a fourth aspect, examples of the present disclosure provide a computer readable storage medium having computer instructions stored thereon, the computer instructions causing a computer to implement the method of determining data hotness in the above first aspect or in any of its corresponding implementations.

The present disclosure provides the method of determining data hotness, the memory controller, the memory system, and the computer readable storage medium, wherein the data distribution state of the data stored in the virtual block is represented by the ratio between the page table entry region count and the valid data count, and the data distribution state is involved in a judgement of hot or cold data. As such, the data hotness may be judged according to the page table entry region count, so as to facilitate separating the cold data from the hot data according to the data hotness, so that the cold data can be sunk better to reduce the migrations of the cold data, thereby reducing write amplification caused by garbage collection and ensuring the storage performance of the memory system as well as an amount of data that can be written to the memory system.

Although the examples of the present disclosure are described in conjunction with the drawings, a person skilled in the art can make various modifications and variations without departing from the spirit and scope of the present disclosure, and such modifications and variations fall within the scope defined by the appended claims.

What is claimed is:

1. A method of determining data hotness, comprising:
acquiring a page table entry region count corresponding to a virtual block and a valid data count of the virtual block, wherein the virtual block includes at least one memory block in a memory device;
determining a data distribution state of data stored in the virtual block based on the page table entry region count and the valid data count; and
determining data hotness of the data stored in the virtual block based on the data distribution state.

2. The method of claim 1, wherein the acquiring the page table entry region count corresponding to the virtual block includes:
acquiring a page table entry bitmap corresponding to the virtual block, the page table entry bitmap representing a distribution state, in various page table entry regions, of logical addresses of the data stored in the virtual block; and
determining the page table entry region count based on the distribution state, in various page table entry regions, of the logical addresses of the data stored in the virtual block.

3. The method of claim 1, wherein the determining the data hotness of the data stored in the virtual block based on the data distribution state includes:
acquiring an update time interval of a block mapping relationship and a relative erase/program count corresponding to the virtual block;
determining an erase/program state corresponding to the virtual block based on the update time interval and the relative erase/program count; and
determining the data hotness of the data stored in the virtual block based on the erase/program state and the data distribution state.

4. The method of claim 3, wherein the acquiring the update time interval of the block mapping relationship corresponding to the virtual block includes:
acquiring latest update time of the block mapping relationship of the virtual block; and
determining a time difference between the latest update time and current time, and
determining the time difference as the update time interval.

5. The method of claim 3, wherein the acquiring the relative erase/program count corresponding to the virtual block includes:
acquiring a first erase/program count corresponding to the virtual block and a second erase/program count of another virtual block currently in an unused state; and
determining the relative erase/program count based on a difference between the first erase/program count and the second erase/program count.

6. The method of claim 3, wherein the determining the data hotness of the data stored in the virtual block based on the erase/program state and the data distribution state includes:
adjusting the data distribution state according to a preset adjustment coefficient to generate an adjusted data distribution state; and
determining the data hotness of the data stored in the virtual block based on the erase/program state and the adjusted data distribution state.

7. The method of claim 6, wherein the determining the data hotness of the data stored in the virtual block based on the erase/program state and the adjusted data distribution state includes determining a first ratio between the erase/program state and the adjusted data distribution state, the first ratio to represent the data hotness of the data stored in the virtual block.

8. The method of claim 7, wherein the larger the first ratio, the colder the data stored in the virtual block.

9. The method of claim 1, wherein the determining the data distribution state of data stored in the virtual block based on the page table entry region count and the valid data count includes determining a second ratio between the page table entry region count and the valid data count, and using the second ratio to represent the data distribution state.

10. The method of claim 9, wherein the larger the second ratio, the more discrete the data distribution state.

11. The method of claim 1, further including:
determining, based on data hotness of data stored in each virtual block and a valid data count of each virtual block, a first target virtual block for garbage collection; and
performing first garbage collection on the first target virtual block.

12. The method of claim 11, wherein the determining, based on the data hotness of the data stored in each virtual block and the valid data count of each virtual block, the first target virtual block for garbage collection including:
acquiring a data storage volume of each virtual block;
determining a valid data proportion of each virtual block based on the valid data count and the data storage volume corresponding to each virtual block;
determining a collection parameter value corresponding to each virtual block according to the valid data proportion and the data hotness; and
determining the first target virtual block for garbage collection from a plurality of virtual blocks based on the collection parameter value.

13. The method of claim 12, wherein the larger the collection parameter value, the larger a collection value of the first target virtual block.

14. The method of claim 1, further including:
detecting whether an erase/program count difference between various virtual blocks is greater than a preset threshold;
when the erase/program count difference is greater than the preset threshold, determining cold data based on data hotness of data stored in a virtual block having a smaller erase/program count in two virtual blocks compared with each other;
determining a second target virtual block having a larger erase/program count in the two virtual blocks compared with each other, wherein an erase/program count of the second target virtual block is greater than an erase/program count of the virtual block where the cold data is located; and
migrating the cold data into the second target virtual block, and releasing a memory block in the virtual block that stores cold data.

15. The method of claim 1, further including:
determining a third target virtual block having a minimum valid data count; and
performing second garbage collection on the third target virtual block.

16. A memory controller, comprising:
a cache and a processor communicatively connected with each other, the cache having computer instructions stored therein, the computer instructions when executed by the processor perform a method of determining data hotness, the method including:
acquiring a page table entry region count corresponding to a virtual block and a valid data count of the virtual block, wherein the virtual block includes at least one memory block in a memory device;
determining a data distribution state of data stored in the virtual block based on the page table entry region count and the valid data count; and
determining data hotness of the data stored in the virtual block based on the data distribution state.

17. A memory system, comprising:
a memory device including a memory array, the memory array including a plurality of memory blocks; and
a memory controller coupled with the memory device and configured to:
acquire a page table entry region count corresponding to a virtual block and a valid data count of the virtual block, wherein the virtual block includes at least one of the memory blocks;
determine a data distribution state of data stored in the virtual block based on the page table entry region count and the valid data count; and
determine data hotness of the data stored in the virtual block based on the data distribution state.

18. The memory system of claim 17, wherein the memory controller is further configured to:
determine, based on data hotness of data stored in each virtual block and a valid data count of each virtual block, a first target virtual block for garbage collection; and
perform first garbage collection on the first target virtual block.

19. The memory system of claim 18, wherein the memory controller is further configured to:
acquire a data storage volume of each virtual block;
determine a valid data proportion of each virtual block based on the valid data count and the data storage volume corresponding to each virtual block;
determining a collection parameter value corresponding to each virtual block according to the valid data proportion and the data hotness; and
determine the first target virtual block for garbage collection from a plurality of virtual blocks based on the collection parameter value.

20. The memory system of claim 17, wherein the memory controller is further configured to:
detect whether a erase/program count difference between various virtual blocks is greater than a preset threshold;
when the erase/program count difference of the virtual blocks is greater than the preset threshold, determine cold data based on data hotness of data stored in a virtual block having a smaller erase/program count in two virtual blocks compared with each other;
determine a second target virtual block having a larger erase/program count in the two virtual blocks compared with each other, wherein an erase/program count of the second target virtual block is greater than an erase/program count of the virtual block where the cold data is located; and
migrate the cold data into the second target virtual block, and release a memory block in the virtual block that stores cold data.
